(19) United States
(12) Patent Application Publication
(10) Pub. No.: US 2012/0016699 A1
(43) Pub. Date: Jan. 19, 2012

(54) SYSTEMS AND METHODS FOR INVENTORY MANAGEMENT

(75) Inventors: Andrew Gilmore, Oxfordshire (GB); Brian Smith, Milton, GA (US); Joe Kulbago, Grayson, GA (US); Kim Rutter, Roswell, GA (US); Brian Denny, Atlanta, GA (US); Criss Chrestman, Buford, GA (US)

(73) Assignee: AGILYSYS NV, LLC, Alpharetta, GA (US)

(21) Appl. No.: 13/027,373

(22) Filed: Feb. 15, 2011

Related U.S. Application Data
(60) Provisional application No. 61/304,631, filed on Feb. 15, 2010.

(51) Int. Cl. G06Q 50/00

(52) U.S. Cl. 705/5; 705/314

(57) ABSTRACT

Computer-implemented systems and methods provide for attribute-based inventory management. In the attribute-based inventory management, any one or more discrete attributes of an inventory item can be used to manage the inventory item. Management of the inventory item includes, for example, identifying the availability of the inventory item and identifying a rate to be charged for the inventory item. This attributes-based model for inventory management is highly flexible and scalable.

### RELATED APPLICATION

The present application is being filed as a U.S. non-provisional patent application claiming priority/benefit under 35 U.S.C. § 119(e) from the U.S. provisional patent application having Ser. No. 61/304,631 and filed on Feb. 15, 2010, the entire disclosure of which is incorporated herein by reference.

### FIELD

The general inventive concepts relate to inventory management and, more particularly, to systems and methods for inventory management.

### BACKGROUND

Property management systems are computerized systems that facilitate the management of properties, often using a single software application. For example, in the hospitality industry, a property management system is a computerized system used to manage guest bookings, online reservations, point of sale, telephone and other amenities. Hotel property management systems may interface with central reservation systems, revenue or yield management systems, front office systems, back office systems, and point of sale systems.

In this manner, property management systems are useful for managing the property's inventory. For example, in the case of a hotel property, the property management system can be used to manage the hotel's rooms.

In the hospitality industry, rooms are classified based on a relatively limited set of categories. These categories include characteristics of, related to, or imposed on the room. For example, hotel rooms are often classified based on, and only on, the combination of the following three categories: (1) room quality, (2) bed size, and (3) smoking preference. Room quality is a somewhat arbitrary way of differentiating rooms, usually based on price. For example, the room quality category could be used to divide the inventory of rooms into standard rooms (S), deluxe rooms (D), and premium rooms (P). Bed size refers to the configuration of bedding in a room. For example, the bed size category could be used to divide the inventory of rooms into single twin bed (ST) rooms, double twin bed (DT) rooms, queen bed (SQ) rooms, and king bed (SK) rooms. Smoking preference indicates whether or not a room has been designated a smoking permissible room. Thus, the smoking preference category is used to divide the inventory of rooms into smoking-allowed (SA) rooms and non-smoking (NS) rooms.

Codes representing these categories are used to classify the inventory of rooms, with the codes being used by the property management system to manage the inventory of rooms. Based on the categories described above, each room is assigned one, and only one, of 24 codes derived from all possible combinations of the categories. For example, a deluxe room having a king-sized bed and in which smoking is allowed is assigned the code DSKSA, whereas a standard room having a single twin bed and in which smoking is prohibited is assigned the code SSTNS.

By their very nature, the codes involve multiple categories. These codes are hard-coded or otherwise input into the property management system in a manner in which they are not readily separable into their component categories.

### SUMMARY

The general inventive concepts contemplate computer-implemented systems and methods for attribute-based inventory management. In one embodiment, attribute-based inventory management provides relational processing and views of inventory. In this manner, inventory having similar attributes can be identified, viewed and manipulated.

In one exemplary embodiment, computer-implemented systems and methods for attribute-based inventory management are disclosed. The computer-implemented systems and methods include or otherwise use one or more computers for implementing attribute-based inventory management logic, which can be embodied as a series of circuits, programs, modules, functions, routines, steps, software, or the like. The attribute-based inventory management logic defines each inventory item by attributes of the inventory item. Thereafter, the inventory item can be managed, tracked, modified, marketed, sold, or otherwise processed based on any one or more of its attributes.

In one exemplary embodiment, a computer-implemented system for attribute-based inventory management comprises: a computer; and a storage device storing data on a plurality of inventory items, wherein said data includes a plurality of attributes, wherein each of the inventory items is associated with one or more of the attributes, and wherein the system is operable to identify all of the inventory items corresponding to any one of the attributes.

In one exemplary embodiment, a computer-implemented method for attribute-based inventory management comprises: defining a plurality of attributes for a plurality of inventory items; associating at least one of the attributes with each of the inventory items; filtering the inventory items to determine which, if any, of the inventory items correspond to any one or more of the attributes, and determining a rate to be charged for any one of the inventory items based, at least in part, on its attributes.

Numerous advantages and features attributable to the general inventive concepts will become readily apparent from the following detailed description of exemplary embodiments, from the claims and from the accompanying drawings.

### BRIEF DESCRIPTION OF THE DRAWINGS

For a fuller understanding of the nature and advantages of the general inventive concepts, reference should be had to the following detailed description taken in connection with the accompanying drawings, in which:

FIG. 1 is a diagram of a computer for use in a property management system and/or for implementing a property management method, according to one exemplary embodiment.

FIG. 2 is a diagram of a property management system, according to one exemplary embodiment.

FIG. 3 is a diagram of a property management system, according to one exemplary embodiment.

FIG. 4 shows a user interface for defining room attributes, according to one exemplary embodiment.

FIG. 5 shows a user interface for defining room attribute combinations, according to one exemplary embodiment.

FIG. 6 shows a user interface for assigning or otherwise associating room attributes with corresponding rooms, according to one exemplary embodiment.

FIG. 7 shows a user interface for assigning priorities among assigned room attributes and attribute combinations, according to one exemplary embodiment.

FIG. 8 shows a user interface for selecting attributes to be used in generating a room availability report, according to one exemplary embodiment.

FIG. 9 shows a user interface for displaying a room availability report, according to one exemplary embodiment.

FIG. 10 shows a user interface for displaying a room rate report, according to one exemplary embodiment.

FIG. 11 is a diagram illustrating the process flow in determining the availability of a room based on attributes included in a reservation request, according to one exemplary embodiment.

FIG. 12 describes an attribute smoothing algorithm, according to one exemplary embodiment.

FIG. 13 is a diagram of a property management method, according to one exemplary embodiment.

### DESCRIPTION

While the general inventive concepts are susceptible of embodiment in many different forms, there are shown in the drawings and will be described herein in detail specific embodiments thereof with the understanding that the present disclosure is to be considered as an exemplification of the principles of the general inventive concepts. Accordingly, the general inventive concepts are not intended to be limited to the specific embodiments illustrated herein.

The following includes definitions of exemplary terms used throughout the disclosure. Both singular and plural forms of all terms fall within each meaning:

“Logic,” synonymous with “circuit” as used herein includes, but is not limited to, hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing unit” as used herein includes, but is not limited to, any programmed or programmable electronic device that can store, retrieve, and process data.

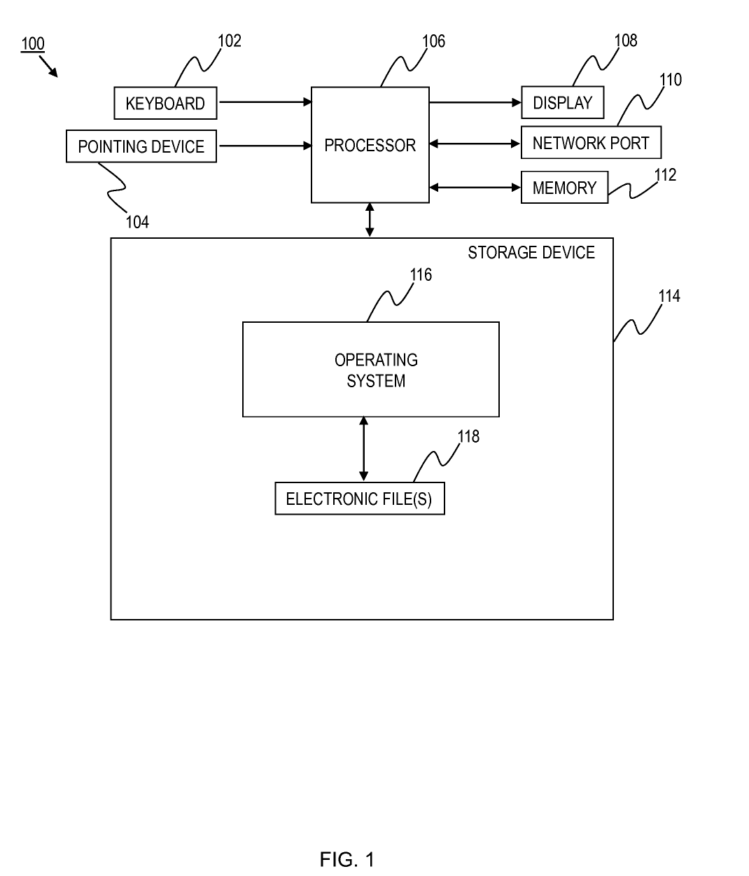

In accordance with the general inventive concepts, disclosed herein are exemplary embodiments of property management systems and property management methods that provide for attribute-based inventory management. FIG. 1 shows a computer 100 (e.g., a general purpose desktop or laptop computer) for use in a property management system and/or a property management method, according to one exemplary embodiment.

The computer 100 includes a processing means, such a CPU 106, and memory, such as RAM 112, for use by the processing means. The computer 100 also includes input means, such as a keyboard 102 and a mouse 104, and output means, such as a monitor 108. The monitor can be, for example, an LCD or CRT display. The output means can include any device or mechanism for outputting signals generated by the computer 100. For example, the output means could include speakers (not shown) for outputting audio.

The computer includes a permanent and/or semi-permanent storage means, such as a hard disk drive 114. The hard disk drive 114 can be used to store software applications, such as an operating system 116, and/or data in the form of electronic files 118. The computer 100 further includes a networking means, such as a network port or adapter 110. The network adapter 110 can be, for example, an Ethernet adapter. The network adapter 110 allows the computer 100 to be connected to and communicate over a network, such as the Internet. The network adapter 110 can support, for example, wired or wireless communication over the network.

Various modifications could be made to the computer 100 without departing from the spirit and scope of the general inventive concepts. The computer 100 can be configured and used as a client and/or a server computer.

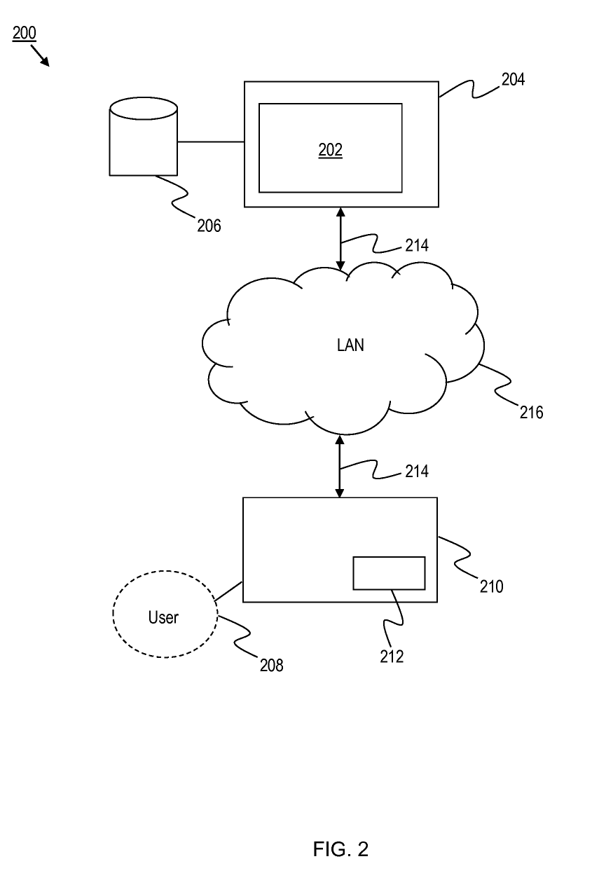

As shown in FIG. 2, a property management system 200, according to one exemplary embodiment, includes property management software 202 installed on a server computer 204 for managing inventory items of one or more properties. The server computer 204 utilizes a database 206 to store information (e.g., records) on the inventory items. The database 206 can be implemented, for example, on the hard disk drive 114 of the server computer 204 and/or across one or more discrete storage devices.

A user 208 of the property management system 200, such as a hotel booking agent, can use a client computer 210 to access the property management software 202 running on the server computer 204. In one exemplary embodiment, the system 200 authenticates the user 208 before granting access to the property management software 202. As one example, the system 200 may verify a username and a password input by the user 208.

The client computer 210 is used to display a user interface 212 generated by the server computer 204 to the user 208. By interacting with the user interface 212, the user 208 is able to effectively manage the inventory items, as described in more detail below.

In one exemplary embodiment, the server computer 204 is local to the client computer 210, with data communications 214 between the server computer 204 and the client computer 210 taking place over a local area network 216.

In one exemplary embodiment, the server computer 204 and the client computer 210 are integrated (e.g., into a single computer 100), with data communications occurring internally.

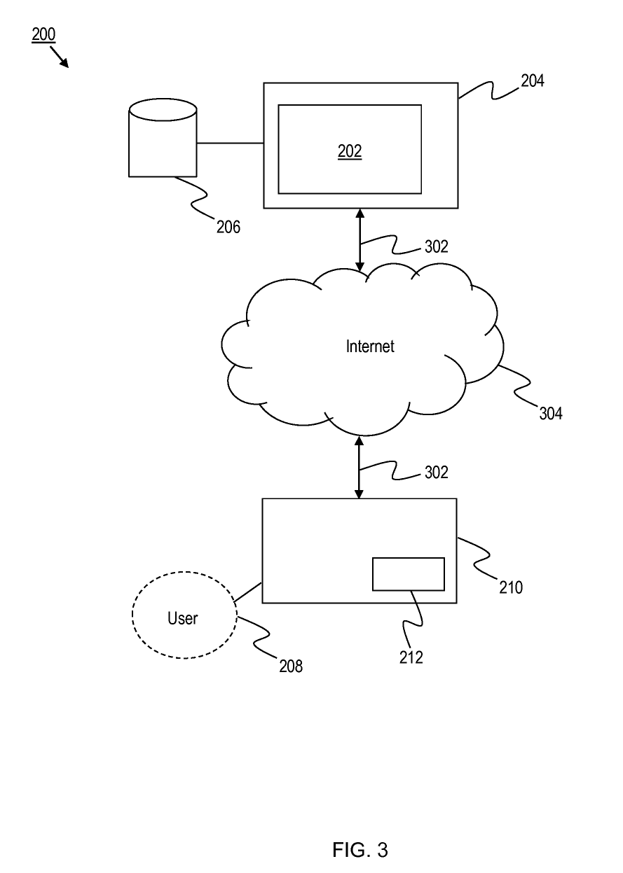

In one exemplary embodiment, shown in FIG. 3, the server computer 204 is remote from the client computer 210, with data communications 302 between the server computer 204 and the client computer 210 taking place over a wide area network or the Internet.

In one exemplary embodiment, the property management system 200 is a Web-based application, such that the client computer 210 can access the property management software 202 running on the server computer 204 using a standard Web browser (e.g., the Internet Explorer browser, Internet Explorer being a registered trademark of Microsoft Corporation) or similar application. In this manner, the property management system 200 does not require that any additional software is installed on the client computer 210.

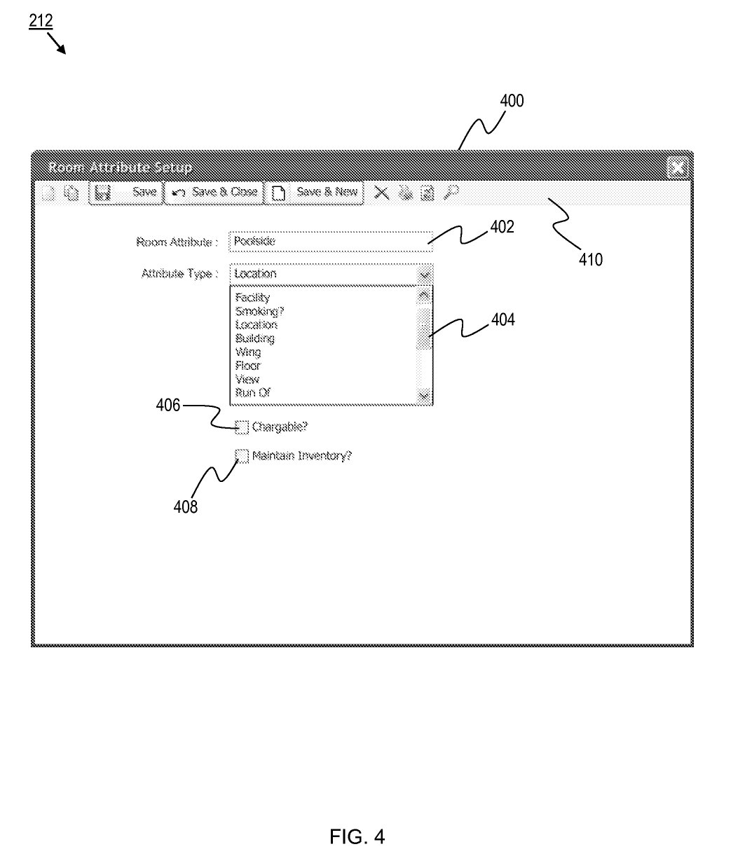

As noted above, the property management software 202 generates a user interface 212 to promote interaction between the user 208 and the property management system 200, wherein an attribute-based inventory model for managing the inventory of one or more properties is implemented. The user interface 212 includes many different display screens for implementing and/or utilizing the attribute-based inventory model. As used herein, the term display screen can encompass, for example, text boxes, dialog boxes, windows, menus, tool bars, buttons, pop-up screens, and other combinations and variations thereof. Various exemplary display screens of the user interface 212 are shown in FIGS. 4-10, in the context of a property management system for managing rooms in a hotel.

FIG. 4 shows a display screen 400 of the user interface 212, according to one exemplary embodiment. The display screen 400 allows the user 208 (or other authorized user, such as an administrator of the property management system 200) to define or otherwise setup one or more attributes for a room. The display screen 400 includes a text entry box 402 for naming a room attribute to be defined. The display screen 400 also includes a pull-down menu 404 for selecting from a list of pre-defined attribute types or categories. Exemplary attribute types include facility, smoking preference, location, building, wing, floor, view, and run of The display screen 400 further includes check boxes 406 and 408 for indicating whether the defined attribute is to be a chargeable attribute and whether an inventory summary is maintained for this defined attribute, respectively.

A chargeable attribute is one in which there is some cost to a guest for that attribute. An example of this is a refrigerator attribute where some rooms have refrigerators and others do not. This would be considered inventoried (i.e., maintained in inventory) in that the inventory model would always know how many of the rooms possessing that attribute (i.e., having refrigerators as a permanent part of their description) are reserved at any given point in time. There are some room attributes that may be inventoried but not chargable (e.g., a “near elevator” attribute). There are typically no attributes that are chargable but not inventoried. Certain chargable items can be added to the reservation ad hoc, but would not need to be inventoriable items such as “parking.”

The display screen 400 also includes a toolbar 410 that provides numerous standard functions, which facilitate setup of the attributes for the rooms. The standard functions include, for example, saving the room attribute setup, deleting the room attribute setup, printing the room attribute setup, refreshing the room attribute setup, and searching the room attribute setup.

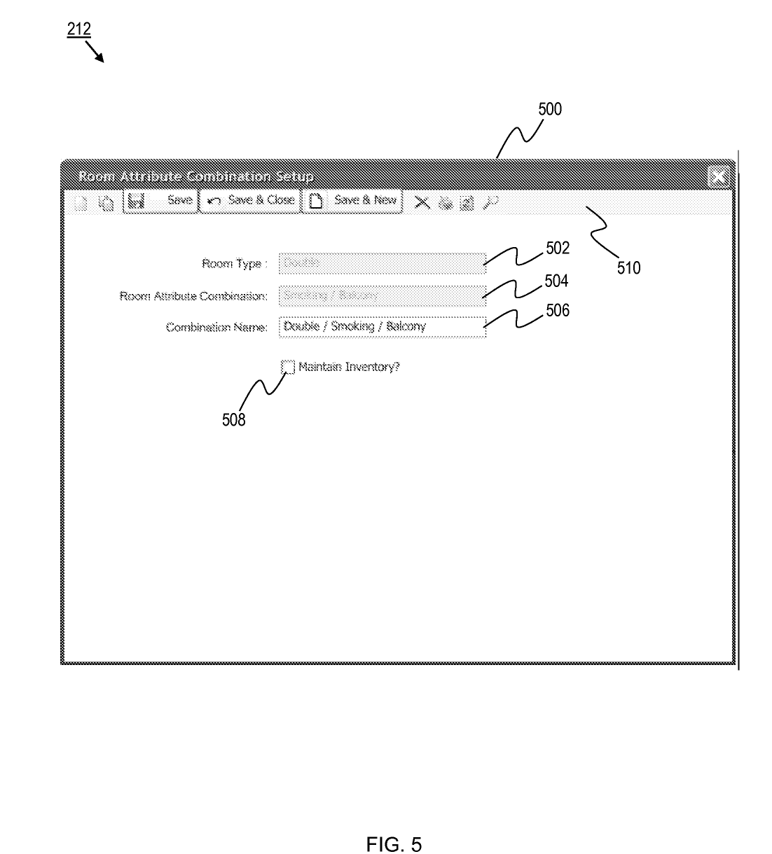

FIG. 5 shows a display screen 500 of the user interface 212, according to one exemplary embodiment. The display screen 500 allows a user (e.g., the user 208) to define or otherwise setup an attribute combination. An attribute combination is a combination of two or more discrete attributes, associated with a specific room. These combinations of discrete attributes are maintained and managed in the inventory model.

Flexibility of the property management system 200 is increased by allowing the user to work with discrete attributes and/or combinations of attributes. For example, attribute combinations can be used to define the more traditional combined categories (e.g., room type, bedding configuration, and smoking preference), while maintaining the attribute-level management of the inventory. As another example, attribute combinations can be used to divide the inventory of rooms into several general categories, while the use of additional attributes can be used to further differentiate the rooms among and/or across the general categories.

The display screen 500 includes three text boxes 502, 504, and 506. The text box 502 is for inputting a room type for the attribute combination. In the example shown in FIG. 5, the input room type is “Double.” The text box 504 is for inputting a room attribute combination, i.e., a combination of two or more discrete attributes. In the example shown in FIG. 5, the room attribute combination is “Smoking/Balcony.” The text box 506 is for naming the attribute combination. In the example shown in FIG. 5, the attribute combination is named “Double/Smoking/Balcony.”

The display screen 500 further includes check box 508 for indicating whether an inventory summary is maintained for the defined attribute combination. If an attribute to be used in an attribute combination is not inventoried (i.e., using check box 408 in display screen 400), then any attribute combination including the non-inventoried attribute cannot be setup and/or will not be inventoried.

In general, maintaining inventory is the practice of applying managements rules for controlling over- or under-sell of any given attribute or combination of attributes. Since different attributes can be assigned to rooms in any combination, keeping this inventory in line (e.g., balanced) requires complex and quick analysis during each transaction. The property management system 200 performs these functions (i.e., keeps the inventory in balance) under the following conditions: (i) varying arrival and departure dates by guests; (ii) varying numbers of rooms per guest; (iii) varying combinations of rooms (each with their own attributes) that are assembled to create suites; (iv) all future dates as discrete entities; (v) multiple hotels within one database; (vi) management-directed quantities to over or undersell any attribute; and (vii) specific rooms that are not assigned at the time of reservation, with instead only a collection of attributes being committed to the guest.

The display screen 500 also includes a toolbar 510 that provides numerous standard functions, which facilitate setup of the attribute combinations. The standard functions include, for example, saving the room attribute combination setup, deleting the room attribute combination setup, printing the room attribute combination setup, refreshing the room attribute combination setup, and searching the displayed room attribute combination setup.

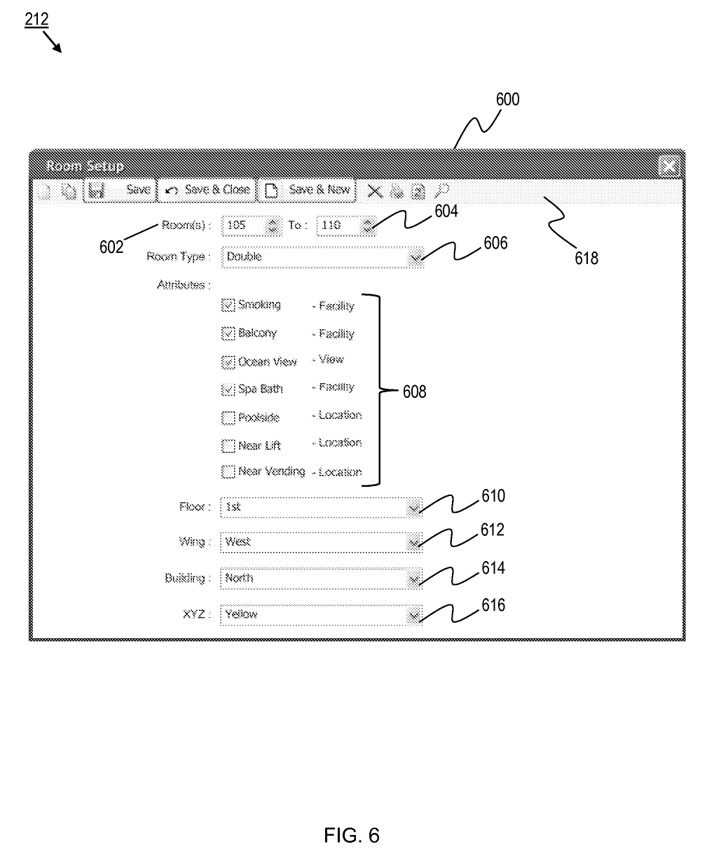

FIG. 6 shows a display screen 600 of the user interface 212, according to one exemplary embodiment. The display screen 600 allows a user (e.g., the user 208) to assign predefined attributes to a room or block of rooms. The display screen 600 includes a pair of text boxes 602, 604 for specifying a range of rooms for which the selected attributes will be assigned. In particular, the text box 602 is used to indicate a starting room number and the text box 604 is used to indicate an ending room number, wherein the starting room number to the ending room number are the range of rooms for which the attributes will be assigned. If the starting room number and the ending room number are the same, then the selected attributes will be assigned only to that room number. In the example shown in FIG. 6, the attributes are being set for rooms 105 to 110.

The display screen 600 includes a pull-down menu 606 for selecting a room type for the room or range of rooms. In the example shown in FIG. 6, the currently selected room type is “Double.”

The display screen further includes a collection of check boxes 608 that represent various attributes which have been defined for the inventory of rooms. The displayed attributes each include one of the aforementioned check boxes 608, an attribute name, and an attribute type. In the example shown in FIG. 6, the attributes “Smoking,” “Balcony,” and “Spa Bath” are all facility type attributes, i.e., they all relate directly to a room in some manner. For example, “Smoking” indicates that smoking is allowed in the room; “Balcony” indicates that the room includes a balcony; and “Spa Bath” indicates that the room includes a spa bath. Other attributes are non-facility attributes, i.e., they either do not relate to a room or only indirectly relate to a room. As shown in FIG. 6, the attribute “Ocean View” is a view type attribute, i.e., a non-facility attribute. A view type attribute relates to a view from a room. For example, “Ocean View” indicates that an ocean can be seen clearly from the room. As also shown in FIG. 6, the attributes “Poolside,” “Near Lift,” and “Near Vending” are all location type attributes, i.e., non-facility attributes. A location attribute relates to a location of a room relative to another object, service, location, or the like. For example, “Poolside” indicates that the room is adjacent to a swimming pool on the property; “Near Lift” indicates that the room is in close proximity to a lift; and “Near Vending” indicates that the room is in close proximity to one or more vending machines. Using the check boxes 608, the user can assign one or more of the attributes to the specified room or range of rooms (e.g., rooms 105 to 110).

The display screen 600 includes pull-down menus 610, 612, 614, and 616 for selecting additional attributes of and/or specifying additional information on the room or range of rooms. The pull-down menu 610 is used to specify a floor on which a room is located. In the example shown in FIG. 6, the selected rooms are on the 1st floor. The pull-down menu 612 is used to specify a wing in which a room is located. In the example shown in FIG. 6, the selected rooms are in the West wing. The pull-down menu 614 is used to specify a building in which a room is located. In the example shown in FIG. 6, the selected rooms are in the North building.

The pull-down menu 616 is used to indicate that the hotel management can specify anything else as an inventory item attribute. The previous attribute categories are merely examples. The property management system 200 allows a user (e.g., the user 208) to specify any room attributes they want, with the XYZ label for the pull-down menu 616 being a reminder or indicator that all of the attribute types and attribute values, including their labels, are configurable. The user could call the attribute category corresponding to the pull-down menu 616 anything, since the property management system 200 gives no importance to the labels themselves.

The display screen 600 also includes a toolbar 618 that provides numerous standard functions, which facilitate setup of the rooms. The standard functions include, for example, saving the room setup, deleting the room setup, printing the room setup, refreshing the room setup, and searching the displayed room setup.

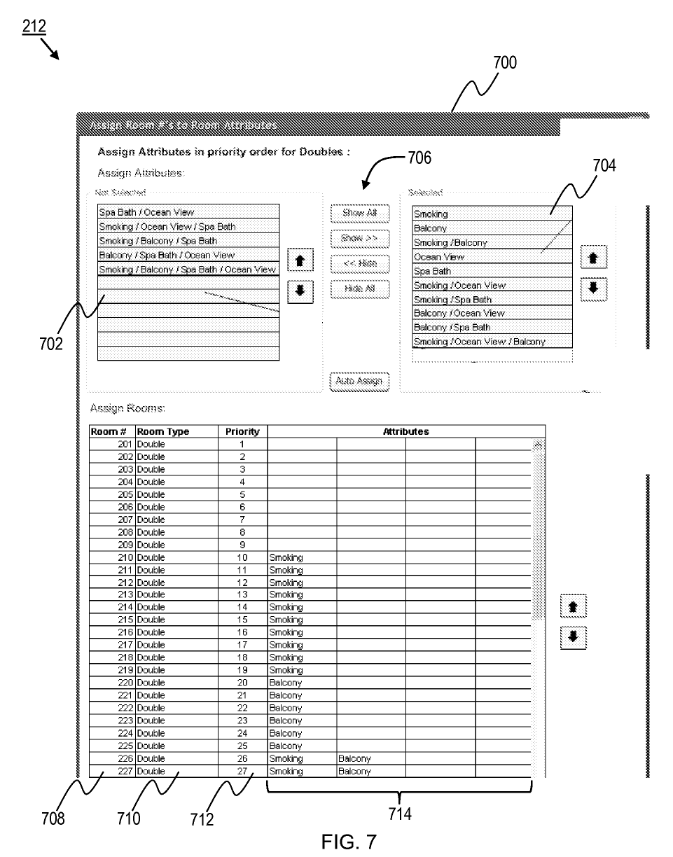

FIG. 7 shows a display screen 700 of the user interface 212, according to one exemplary embodiment. The display screen 700 allows a user (e.g., the user 208) to assign priorities among attributes and/or attribute combinations, in this case, for a selected room type. The display screen 700 includes a list 702 of non-selected (i.e., hidden) attributes and attribute combinations and a list 704 of selected (i.e., shown) attributes and attribute combinations, wherein the lists 702 and 704 together include all of the defined attributes and attribute combinations, or some applicable subset thereof. The display screen 700 includes tools 706 (e.g., buttons) that allow the user to move an attribute or attribute combination from one of the lists 702, 704 to the other. By ordering the attributes and/or attribute combinations in the list 704, priorities are assigned among the rooms of the selected room type.

In the example shown in FIG. 7, twenty-seven rooms 708 (i.e,. rooms 201 to 227) of the selected room type 710 (here, “double”) are each assigned a priority 712 based on the attributes or combination of attributes 714 for the respective rooms. In the property management system 200, the priorities allow the user to, for example, designate that all things being equal one specific room should appear higher on a selection list or be automatically assigned in an auto-assign scenario than another room. This is useful when it is time to assign a specific room to a guest and, thus, does not directly impact the inventory model.

With the various attributes defined and associated with the appropriate rooms, the property management system 200 allows the user 208 to interact with the user interface 212 to manage the inventory of rooms based on their attributes. For example, the property management system 200 allows the user 208 to generate various inventory-related reports based on one or more selected attributes and/or attribute combinations. For example, the user 208 can generate a room availability report to see the availability of rooms matching attribute criteria specified by the user 208. As another example, the user 208 can generate a room rate report for rooms matching attribute criteria specified by the user 208. Based on this system, one of ordinary skill in the art will appreciate that numerous other reports and other presentations of information could be provided by the property management system 200.

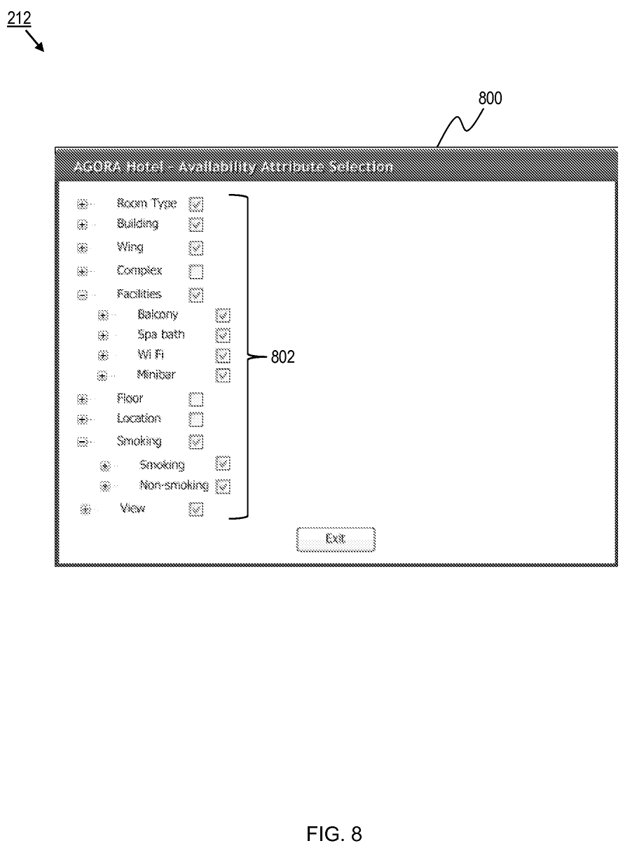

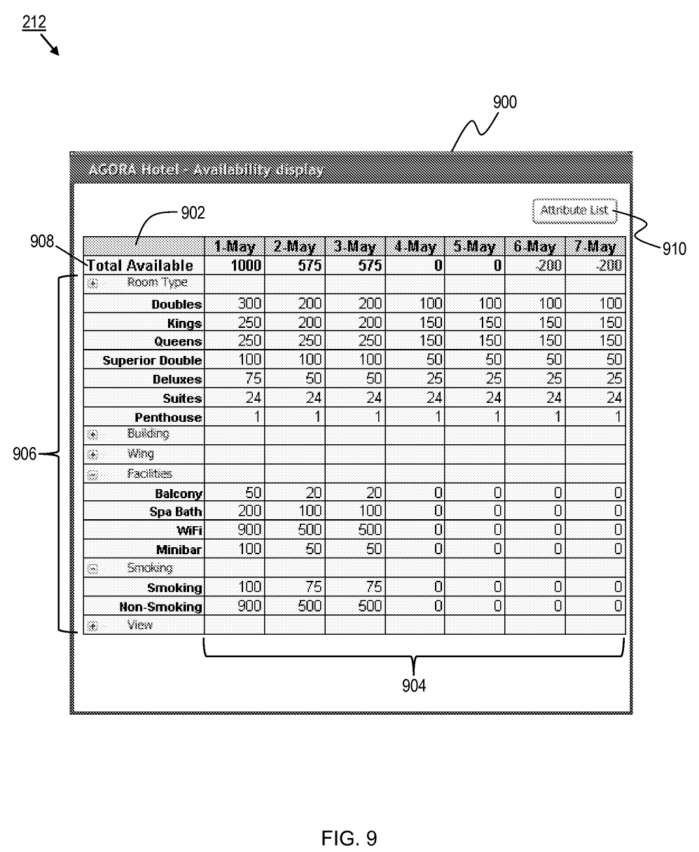

FIG. 8 shows a display screen 800 of the user interface 212, according to one exemplary embodiment. The display screen 800 allows a user (e.g., the user 208) to select from among all of the defined attributes 802, or some applicable subset thereof, for use in generating a room availability report (see FIG. 9). In the example shown in FIG. 8, the user has selected the following attributes 802 to be used for generating the room availability report: room type, building, wing, facilities (including balcony, spa bath, WiFi, and minibar), smoking designation (including both smoking and non-smoking), and view.

FIG. 9 shows a display screen 900 of the user interface 212, according to one exemplary embodiment. The display screen 900 includes a room availability report 902 based on the attributes 802 selected by the user (see FIG. 8). In the example shown in FIG. 9, the room availability report 902 is in the form of a table with columns 904 representing a range of dates (here, May 1 to May 7) and rows 906 primarily representing the various attributes 802 specified by the user. The intersection of a column 904 and a row 906 is populated with a number representing the number of available rooms for the date corresponding to the intersecting column and the attribute corresponding to the intersecting row. Additionally, a first row 908 in the table is used to aggregate the total available rooms (e.g., among the room types), such that the intersection of a column 904 and the first row 908 and is populated with a number representing the total available rooms for the date corresponding to the intersecting column. Thus, from the table 902, the user can readily see, for example, that 1,000 total rooms are available on May 1, of which 50 have a balcony. In this manner, a relational view is provided for room availability based on room attributes. The relational nature of the exemplified attribute-based inventory system allows the building and/or displaying of inventory satisfying exact attribute information needed at any given time.

The display screen also includes an attribute list button 910. The attribute list button 910 allows the user to modify the attributes 802 being used to generate the room availability report 902, as well as the basis (e.g., room type) for displaying the availability report 902. In this manner, attribute list button 910 allows for new relational attribute room tables to be built and displayed based on modification of the attribute list information input into the system.

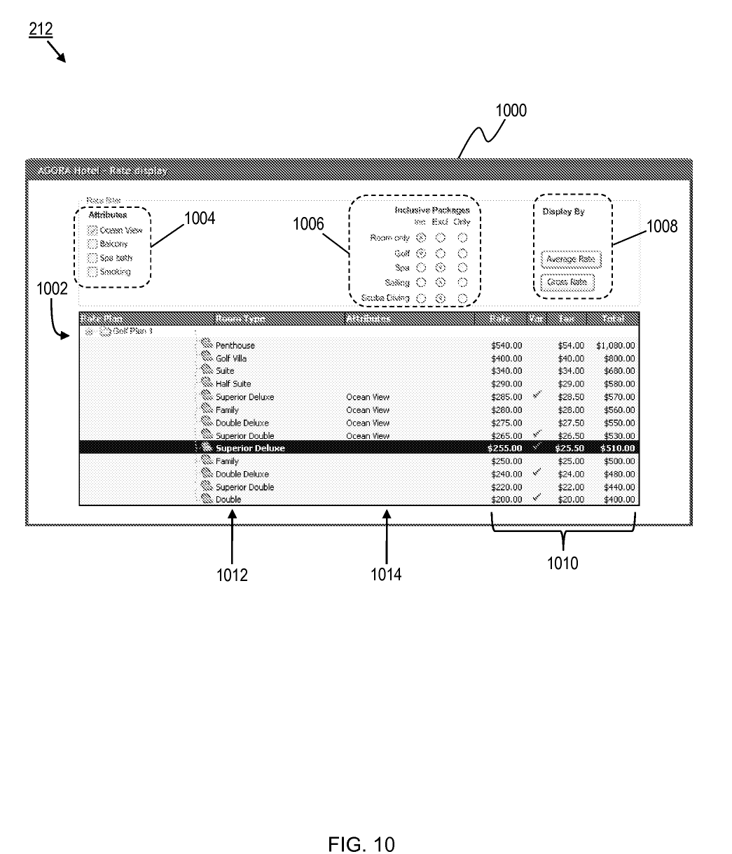

FIG. 10 shows a display screen 1000 of the user interface 212, according to one exemplary embodiment. The display screen 1000 includes a room rate report 1002 based on rate filter information including, for example, room attributes 1004 (or attribute combinations); any related pricing information, such as applicable inclusive packages 1006; and how the rate is to be displayed 1008 (e.g., average rate, gross rate), as selected by a user (e.g., the user 208). In the example shown in FIG. 10, the selected room attribute 1004 is an ocean view, and the selected inclusive packages 1006 include packages of a room and golf. The resulting room rate report 1002 lists rate information 1010, in a manner corresponding to the selected display option 1008, for those rooms matching the room attributes 1004 and applicable inclusive packages 1006. For example, the rooms are listed in the room rate report 1002 by room type 1012 and attributes 1014.

Thus, from the room rate report 1002, the user can readily see, for example, the rate for a Double Deluxe room having a view of the ocean and including a golf package.

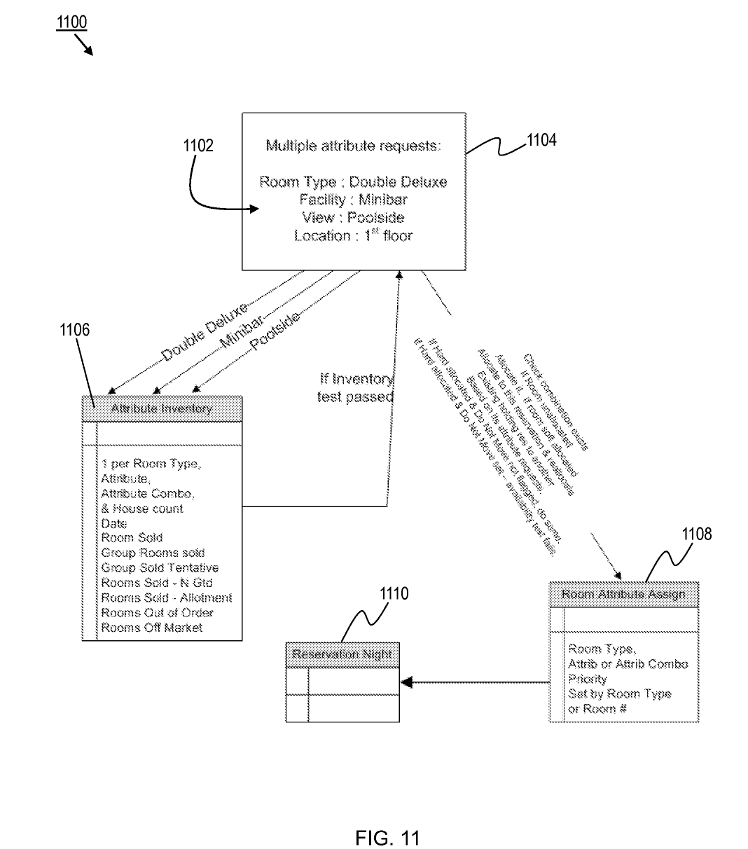

FIG. 11 shows a process flow 1100 for determining the availability of a room matching attributes 1102 in a reservation request 1104, according to one exemplary embodiment. The rectangular elements denote “processing blocks” and represent computer software instructions or groups of instructions. Alternatively, the processing blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

In the example shown in FIG. 11, the attributes 1102 are for a double deluxe room having a minibar and located on the 1st floor by the pool. Using the attributes 1102, inventory records 1106 are queried to determine if the combination of attributes 1102 exists in the inventory. If a room 1108 is found that has the attributes 1102 and if the room is unallocated, then the room 1108 is allocated to a reservation 1110. If the room 1108 is soft allocated, then the room 1108 is allocated to the reservation 1110 and the prior holding reservation is reallocated based on its original reservation request. If the room 1108 is hard allocated but not flagged “Do Not Move,” then the room 1108 is allocated to the reservation 1110 and the prior holding reservation is reallocated based on its original reservation request. If the room 1108 is hard allocated and flagged “Do Not Move,” then the availability test fails with no available room 1108 found matching the attributes 1102.

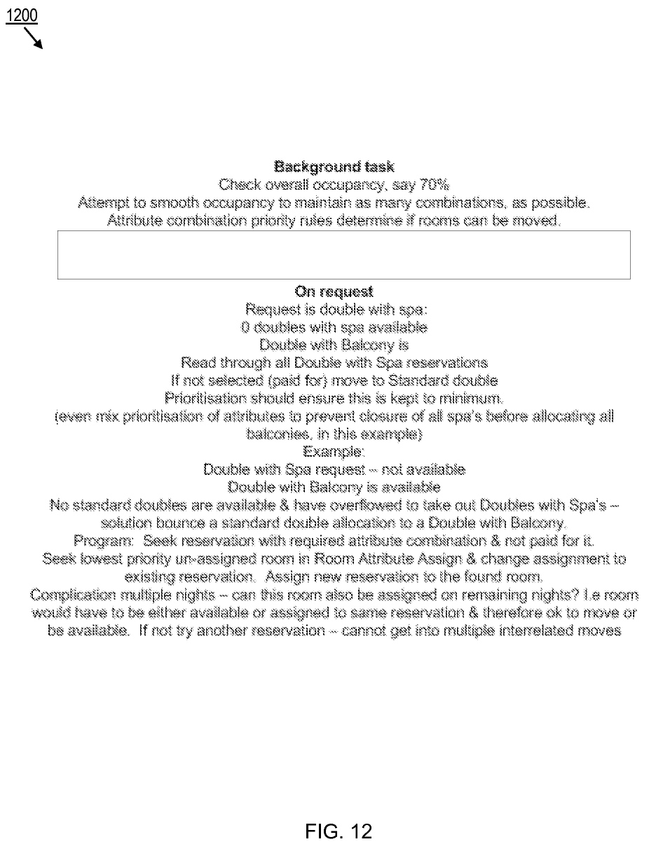

FIG. 12 describes an algorithm 1200 for performing “attribute smoothing,” according to one exemplary embodiment. The attribute smoothing algorithm 1200 attempts to maximize or otherwise increase the number of different available room attribute combinations. In other words, by performing the attribute smoothing process, the property management system 200 presents a “smoothed occupancy” to continue offering the largest number of options for the “next caller.” In this manner, the property management system 200 can dynamically increase the ability of a property to accommodate diverse room requests. In one exemplary embodiment, the attribute smoothing process is implemented using fuzzy logic and/or artificial intelligence.

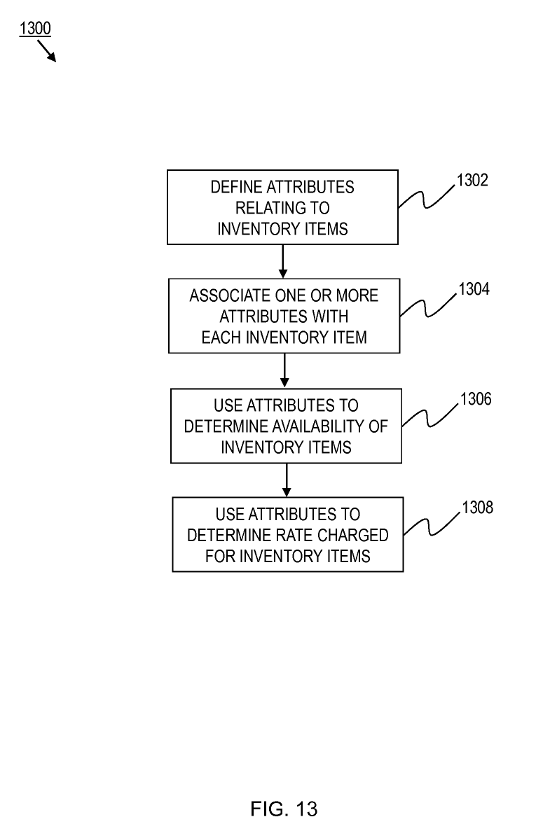

FIG. 13 shows a property management method 1300, according to one exemplary embodiment. In an initial step 1302, attributes (including attribute combinations) of the inventory items (e.g., rooms of a hotel) are defined. Then, in step 1304, the attributes are associated with the various inventory items to differentiate the items at the attribute level. For example, using the attributes, a room with a balcony is differentiated from a room without a balcony. In step 1306, one or more of the attributes are utilized to determine the availability of any associated inventory items. For example, if a customer's only desire is to reserve a room with a view of the ocean, the attribute corresponding to an ocean view can be used to determine whether any rooms with such a view are available, regardless of the other attributes of the rooms. In step 1308, one or more of the attributes are utilized to determine a rate to be charged for any associated inventory items. For example, the rate charged for rooms in the hotel can vary based on the different combinations of attributes of those rooms. In this manner, the hotel may be able to offer more attractive rates to customers by excluding extraneous attributes (and their associated costs) from a room chosen in response to the customer's reservation request.

Thus, the property management method 1300 is highly flexible in that many attributes can be defined and subsequently used to differentiate and otherwise manage the associated inventory on an attribute-by-attribute basis. Additionally, the property management method 1300 provides a more flexible pricing model than conventional property management methods and systems.

The systems and methods of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

The above description of specific embodiments has been given by way of example. From the disclosure given, those skilled in the art will not only understand the general inventive concepts and their attendant advantages, but will also find apparent various changes and modifications to the structures and methods disclosed. For example, although the above exemplary embodiments reference managing rooms in a hotel, the general inventive concepts can be extended to other similar inventory situations, such as managing cabins on a cruise ship. It is sought, therefore, to cover all such changes and modifications as fall within the spirit and scope of the general inventive concept, as defined by the appended claims and equivalents thereof

1. A property management system for processing data associated with a plurality of rooms of at least one property, the property management system comprising:
a computer; and
at least one data storage device,
wherein said computer is in communication with said data storage device,
wherein said data storage device stores said data,
wherein said data includes computer readable instructions for processing by said computer,
wherein said data includes a plurality of first attributes,
wherein said data includes a plurality of second attributes,
wherein each of said rooms is operable to be associated with at least one of said first attributes,
wherein each of said rooms is operable to be associated with at least one of said second attributes,
wherein each of said rooms has an inventory profile including any first attributes associated with said room and any second attributes associated with said room, and
wherein said inventory profiles are used to determine if any of a pluarlity of available rooms will satisfy a room request.

2. The system of claim 1, wherein at least one of said first attributes is a chargeable attribute.

3. The system of claim 1, wherein at least one of said second attributes is a chargeable attribute.

4. The system of claim 1, wherein any of said first attributes and said second attributes can be designated a chargeable attribute.

5. The system of claim 1, wherein a rate associated with a room is based on its inventory profile.

6. The system of claim 1, wherein said first attributes comprise at least one of room quality attributes, bed size attributes, and smoking preference attributes.

7. The system of claim 1, wherein said first attributes consist of room quality attributes, bed size attributes, and smoking preference attributes.

8. The system of claim 1, wherein said first attributes are used to divide an inventory of said rooms into a plurality of general categories, and wherein said second attributes are used to further differentiate said inventory of said rooms amongst said general categories.

9. The system of claim 1, wherein said first attributes are facility type attributes, and wherein said second attributes are non-facility type attributes.

10. The system of claim 9, wherein said second attributes are view type attributes.

11. The system of claim 9, wherein said second attributes are location type attributes.

12. The system of claim 9, wherein said computer allows an authorized user to create a new facility type attribute.

13. The system of claim 9, wherein said computer allows an authorized user to create a new non-facility type attribute.

14. The system of claim 1, wherein said computer allows an authorized user to assign priorities amongst at least one of said first attributes and said second attributes, and wherein said priorities are used to manage said inventory of said rooms.

15. The system of claim 1, wherein said computer allows an authorized user to create a new attribute for associating with any of said rooms, and
wherein said new attribute is one of a first attribute and a second attribute.

16. The system of claim 1, wherein said computer allows an authorized user to edit an existing attribute, and
wherein said existing attribute is one of a first attribute and a second attribute.

17. The system of claim 1, wherein said computer allows an authorized user to delete an existing attribute,
wherein said existing attribute is one of a first attribute and a second attribute.

18. The system of claim 1, wherein said computer performs an attribute smoothing process to increase a number of different inventory profiles amongst said available rooms.

19. The system of claim 1, wherein said inventory profiles are used to determine a room from amongst said available rooms that most closely matches said room request.

20. A property management method for processing data associated with a plurality of rooms of at least one property, the property management method comprising:
defining a pluarlity of first attributes,
defining a plurality of second attributes,
associating at least one of said first attributes with each room,
associating at least one of said second attributes with each room,
defining an inventory profile for each room, said inventory profile including any first attributes associated with said room and any second attributes associated with said room, and
in response to a request for a room, selecting an available room having an inventory profile with attributes that most closely match the attributes specified in said request.
